(19) United States
(12) Patent Application Publication
(10) Pub. No.: US 2008/0128596 A1
(43) Pub. Date: Jun. 5, 2008

(54) LASER TRACKBALL

(76) Inventors: YUNG-LUNG LIU, Taichung Hsien (TW); Shih-Pin Lin, Taichung Hsien (TW)

Correspondence Address: G. LINK CO., LTD., 3550 BELL ROAD, MINOOKA, IL, 60447, US

(21) Appl. No.: 11/564,973

(22) Filed: Nov. 30, 2006

(51) Int. Cl. G06M 7/00

(52) U.S. Cl. 250/221

(57) ABSTRACT

A trackball in one embodiment includes a socket mounted on a PCB and including an upper chamber, a lower chamber in communication with the upper chamber, an opening on a periphery of the lower chamber, rollers disposed around a bottom of the upper chamber, a ball mounted in the upper chamber and rotatably supported by the rollers, a ring cover secured to the socket for projecting an upper portion of the ball therefrom, a light source (e.g., laser diode) mounted in the opening for emitting light onto a lower portion of the ball, and a photosensor mounted under an aperture of the PCB. Rolling the ball will reflect the light from the ball to the photosensor such that the rotational movement of the ball can be converted into a digital signal useable to move a cursor a corresponding distance and direction on a display of, for example, a keyboard.

### BACKGROUND OF THE INVENTION

1. Field of Invention

The present invention relates to trackballs and more particularly to a relatively small laser trackball with improved resolution, the laser trackball adapted to mount on a computer keyboard, a notebook computer, or even on the phone body of a mobile phone.

2. Related Art

Conventionally, a desktop computer is equipped with a trackball or a mouse (or a notebook computer is equipped with a trackball) as a pointing device for cursor on its video display screen. The construction and operation of a conventional optomechanical trackball are detailed below. A ball contacts two shaft encoders and rotation of the ball rotates the shaft encoders. Each shaft encoder comprises an encoding wheel having slits thereon. A light source is positioned on one side of the encoding wheel, while a photosensor is positioned opposite the light source. Rotation of the encoding wheel therebetween causes a series of light pulses to be received by the photosensor. Thereafter, the rotational movement of the ball can be converted into a digital signal useable to move a cursor.

However, the well known trackball suffered from several disadvantages. For example, its mechanism is typically relatively complex in constructions, it is trouble-prone due to foreign objects entering, it has a reduced useful time, it is relatively bulky, and its manipulation or operation is not smooth. Thus, the need for improvement still exists.

### SUMMARY OF THE INVENTION

It is therefore an object of the present invention to provide a trackball for controlling the position of a cursor on a display of a personal computer, a notebook computer, or a mobile phone, comprising a PCB (printed circuit board) including an aperture therethrough; a cylindrical socket mounted on the PCB and including an upper chamber, a lower chamber in communication with the upper chamber, an opening on a periphery of the lower chamber, a plurality of arcuately recessed seats equally spaced around a bottom of the upper chamber, and a plurality of rollers each disposed in the seat; a ball mounted in the upper chamber and having a lower portion rotatably supported by the rollers and being partially projected into the lower chamber; a ring cover secured to the socket for allowing an upper portion of the ball partially projected therefrom; a light source mounted in the opening for emitting light onto the lower portion of the ball; and a photosensor mounted under the aperture, whereby rolling the projected upper portion of the ball will reflect the light from the lower portion of the ball to the photosensor through the lower chamber such that the rotational movement of the ball is adapted to convert into a digital signal useable to move the cursor a corresponding distance along a corresponding direction on the display.

It is another object of the present invention to provide a trackball for controlling the position of a cursor on a display of a personal computer, a notebook computer, or a mobile phone, comprising a PCB (printed circuit board) including an aperture therethrough; a cylindrical socket mounted on the PCB and including an upper chamber, a lower chamber in communication with the upper chamber, a plurality of arcuately recessed seats equally spaced around a bottom of the upper chamber, and a plurality of rollers each disposed in the seat; a ball mounted in the upper chamber and having a lower portion rotatably supported by the rollers and being partially projected into the lower chamber; a ring cover secured to the socket for allowing an upper portion of the ball partially projected therefrom; and a unitary member including a light source mounted in the aperture for emitting light onto the lower portion of the ball through the lower chamber, and a photosensor mounted in the aperture besides the light source, whereby rolling the projected upper portion of the ball will reflect the light from the lower portion of the ball to the photosensor through the lower chamber such that the rotational movement of the ball is adapted to convert into a digital signal useable to move the cursor a corresponding distance along a corresponding direction on the display.

In one aspect of the present invention the light source is a laser diode.

In another aspect of the present invention the socket further comprises two opposite projections on a top inner edge, and wherein the ring cover comprises two grooves on an underside adapted to matingly secure to the projections for fastening the ball, the socket, and the ring cover together.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of laser trackball according to the present invention;

FIG. 2 is a longitudinal sectional view of the trackball;

FIG. 3 is an exploded view of the trackball;

FIG. 4 is an environmental view of the trackball mounted on a keyboard; and

FIG. 5 is a longitudinal sectional view of a second preferred embodiment of laser trackball according to the present invention.

### DETAILED DESCRIPTION OF THE INVENTION

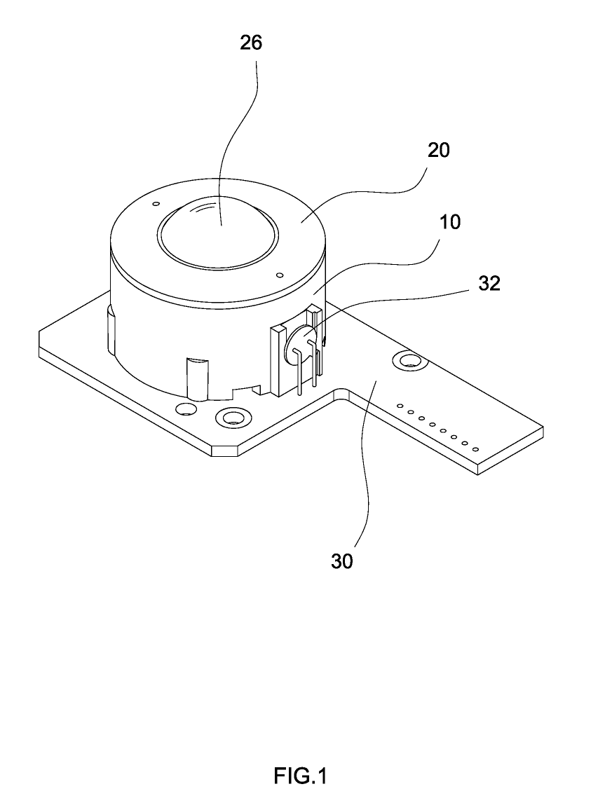

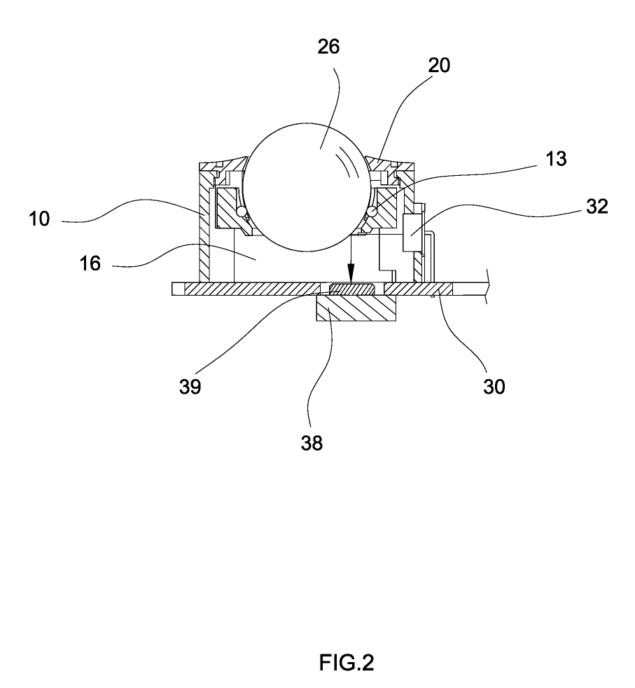

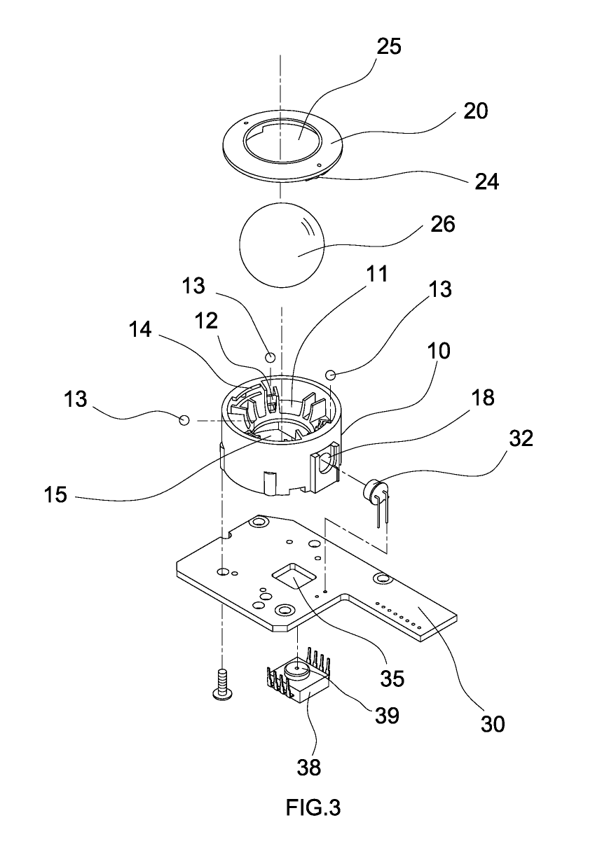

Referring to FIGS. 1 to 4, a laser trackball in accordance with a first preferred embodiment of the present invention comprises a socket 10, a ring cover 20, a ball 26, a light source 32, and a photosensor 38. Each component is discussed in detailed below.

The cylindrical socket 10 is mounted on a PCB (printed circuit board) 30. An internal space of the socket 10 is divided into an upper chamber 11 and a lower chamber 16 in communication with the upper chamber 11 through a circular opening 15 formed therebetween. A plurality of arcuately recessed seats 12 are equally formed around a bottom of the upper chamber 11. A plurality of rollers 13 each is disposed in the seat 12. The ball 26 is mounted in the upper chamber 11 and has its lower portion rotatably supported by the rollers 13. Further, the ball 26 has one portion projected out of a circular opening 25 of the ring cover 20 and the other opposite portion projected out of the opening 15. Two opposite projections 14 are formed on a top inner edge of the socket 10 such that the socket 10 and the ring cover 20 can be secured together by securing the projections 14 to mated grooves 24 on an underside of the ring cover 20 as well known in the art. Also, the ball 26 is positioned. An opening 18 is formed on a periphery of the socket 10 and is in communication with both the lower chamber 16 and the external.

The light source (e.g., laser diode) 32 is mounted in the opening 18. The light source 32 has key characteristics of miniature, low power consumption, and a single frequency. The light source 32 is adapted to emit light of monochrome. The photosensor 38 is a phototransistor mounted under the PCB 30 and is aligned with a rectangular aperture 35 of the PCB 30. The photosensor 38 has a top receiving member 39 disposed in the aperture 35.

An operation of the present invention will be described in detailed below. A user may roll the ball 26 by contacting the palm of the hand with the exposed portion of the ball 26. Light emitted by the light source 32 is reflected by the lower portion of the ball 26 projected into the lower chamber 16 prior to being received by the receiving member 39 of the photosensor 38 through the lower chamber 16. The received light is in the form of a series of light pulses. Thereafter, the rotational movement of the ball 26 can be converted into a digital signal useable to move a cursor a direction and distance proportioned to the rotation of the ball 26 on a video display screen.

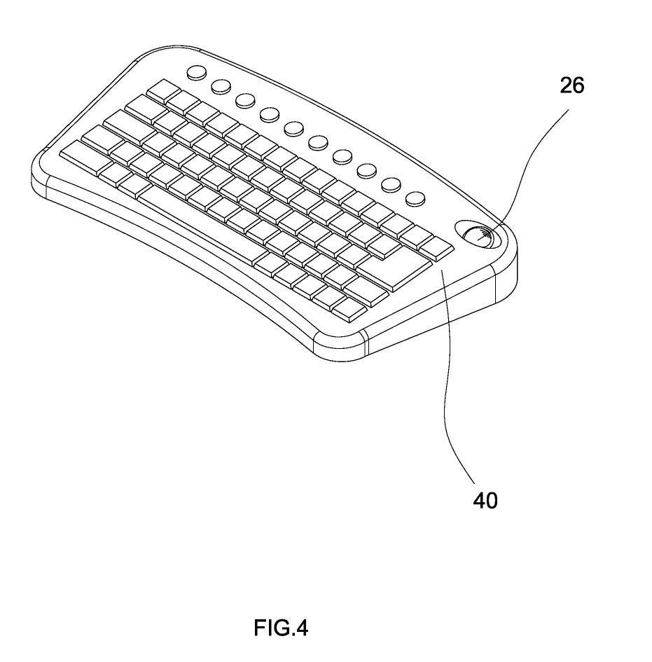

In one application, the small laser trackball is mounted on a computer keyboard 40 (see FIG. 4). In another application, the small laser trackball can be even mounted on the phone body or a mobile phone.

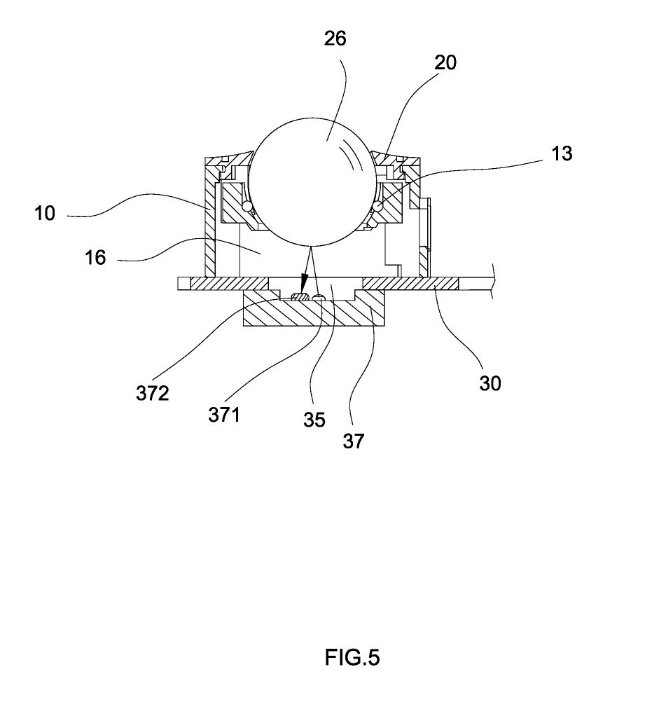

Referring to FIG. 5, a laser trackball in accordance with a second preferred embodiment of the present invention is shown. The second embodiment is identical to the first embodiment, except that a light source (e.g., laser diode) 371 and a spaced photosensor 372 are formed on a top of a light source and sensor unit 37. Both the light source 371 and the photosensor 372 are disposed in the aperture 35.

In either embodiment the laser trackball can obtain an improved resolution. Moreover, the laser trackball is simple in construction, is easy to assemble, and is easy to manipulate or operate.

While the present invention herein disclosed has been described by means of specific embodiments, numerous modifications and variations could be made thereto by those skilled in the art without departing from the scope and spirit of the invention set forth in the claims.

What is claimed is:

1. A trackball for controlling the position of a cursor on a display of a personal computer, a notebook computer, or a mobile phone, comprising:
a PCB (printed circuit board) including an aperture therethrough;
a cylindrical socket mounted on the PCB and including an upper chamber, a lower chamber in communication with the upper chamber, an opening on a periphery of the lower chamber, a plurality of arcuately recessed seats equally spaced around a bottom of the upper chamber, and a plurality of rollers each disposed in the seat;
a ball mounted in the upper chamber and having a lower portion rotatably supported by the rollers and being partially projected into the lower chamber;
a ring cover secured to the socket for allowing an upper portion of the ball partially projected therefrom;
a light source mounted in the opening for emitting light onto the lower portion of the ball; and
a photosensor mounted under the aperture,
whereby rolling the projected upper portion of the ball will reflect the light from the lower portion of the ball to the photosensor through the lower chamber such that the rotational movement of the ball is adapted to convert into a digital signal useable to move the cursor a corresponding distance along a corresponding direction on the display.

2. The laser trackball of claim 1, wherein the light source is a laser diode.

3. The laser trackball of claim 1, wherein the socket further comprises two opposite projections on a top inner edge, and wherein the ring cover comprises two grooves on an underside adapted to matingly secure to the projections for fastening the ball, the socket, and the ring cover together.

4. A trackball for controlling the position of a cursor on a display of a personal computer, a notebook computer, or a mobile phone, comprising:
a PCB (printed circuit board) including an aperture therethrough;
a cylindrical socket mounted on the PCB and including an upper chamber, a lower chamber in communication with the upper chamber, a plurality of arcuately recessed seats equally spaced around a bottom of the upper chamber, and a plurality of rollers each disposed in the seat;
a ball mounted in the upper chamber and having a lower portion rotatably supported by the rollers and being partially projected into the lower chamber;
a ring cover secured to the socket for allowing an upper portion of the ball partially projected therefrom; and
a unitary member including a light source mounted in the aperture for emitting light onto the lower portion of the ball through the lower chamber, and a photosensor mounted in the aperture besides the light source,
whereby rolling the projected upper portion of the ball will reflect the light from the lower portion of the ball to the photosensor through the lower chamber such that the rotational movement of the ball is adapted to convert into a digital signal useable to move the cursor a corresponding distance along a corresponding direction on the display.

5. The laser trackball of claim 4, wherein the light source is a laser diode.

6. The laser trackball of claim 4, wherein the socket further comprises two opposite projections on a top inner edge, and wherein the ring cover comprises two grooves on an underside adapted to matingly secure to the projections for fastening the ball, the socket, and the ring cover together.
